(19) United States
(12) Patent Application Publication
(10) Pub. No.: US 2008/0320570 A1
(43) Pub. Date: Dec. 25, 2008

(54) INFORMATION PROCESSING APPARATUS

(75) Inventor: Shinsuke Yato, Akishima-shi (JP)

Correspondence Address: KNOBBE MARTENS OLSON & BEAR LLP, 2040 MAIN STREET, FOURTEENTH FLOOR, IRVINE, CA, 92614, US

(73) Assignee: KABUSHIKI KAISHA TOSHIBA, Tokyo (JP)

(21) Appl. No.: 12/143,215

(22) Filed: Jun. 20, 2008

(30) Foreign Application Priority Data
Jun. 20, 2007 (JP) 2007-162625

(51) Int. Cl. H04L 9/32; G06F 21/00

(52) U.S. Cl. 726/6; 726/3

(57) ABSTRACT

According to one embodiment, an information processing apparatus includes a wireless communication unit which receives and transmits a voice call wireless signal with a base station, an acceptance unit which accepts instructions related to a privacy protection operation using the voice call wireless signal received by the wireless communication unit, and a control unit which controls the privacy protection operation in accordance with the instructions accepted by the acceptance unit.

### CROSS-REFERENCE TO RELATED APPLICATIONS

This application is based upon and claims the benefit of priority from Japanese Patent Application No. 2007-162625, filed Jun. 20, 2007, the entire contents of which are incorporated herein by reference.

### BACKGROUND

1. Field

One embodiment of the invention relates to a security control technique preferably applied to a portable information processing apparatus such as a notebook type personal computer, for example.

2. Description of the Related Art

In recent years, a battery-powered and portable information processing apparatus called a notebook-sized PC has come into wide use. Along with advances in wireless communications and image processing technologies, notebook-sized PCs having the same level of functionality as desktop information processing apparatuses, called desktop PCs, have been made available. These notebook-sized information apparatuses enable data exchange and viewing of television broadcasting programs wherever the user happens to be, even if the user is not stationary.

Due to the provision of the aforementioned high functionality, which includes portability, however, this entails the likelihood that a user will handle important personal data, or store a large amount of important personal data using the notebook-size PC, which, due to the risk of such PC being lost or stolen, entails the necessity for provision of security countermeasures.

The same problem of potential for information leakage arises with mobile phones. To prevent information leakage from mobile phones, for example, Jpn. Pat. Appln. KOKAI Publication No. 2003-47065 has proposed the following technique. According to the technique, if a user's mobile phone is lost, for example, the user makes a call to the user's mobile phone using a public telephone, a wire-line telephone or other mobile phone and locks the mobile phone. In this way, data is prevented from being leaked.

The information processing apparatus such as a notebook-sized PC is provided with a wireless modem used for wireless communication. The wireless modem has a voice communication function of receiving and sending a wireless signal for voice calls. However, the wireless modem is used for data communication such as an Internet connection, and the voice communication function is mostly unused under the present circumstances. Thus, various proposals to perform a security function via the Internet have been made so far. However, it is impossible to perform the security function by a simple method of making a call using widely distributed public telephones, wire-line telephones or other mobile phones.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary block diagram showing the configuration of an information processing apparatus (personal computer) according to an embodiment of the invention;

FIG. 2 is an exemplary flowchart to explain the procedure of a security function operation of a wireless modem provided in the computer of the embodiment;

FIG. 3 is an exemplary flowchart to explain the procedure of a security function operation of an EC provided in the computer of the embodiment; and

FIG. 4 is an exemplary flowchart to explain the procedure of a security function operation of a BIOS provided in the computer of the embodiment.

### DETAILED DESCRIPTION

Various embodiments according to the invention will be described hereinafter with reference to the accompanying drawings. In general, according to one embodiment of the invention, an information processing apparatus includes a wireless communication unit which receives and transmits a voice call wireless signal with a base station, an acceptance unit which accepts instructions related to a privacy protection operation using the voice call wireless signal received by the wireless communication unit, and a control unit which controls the privacy protection operation in accordance with the instructions accepted by the acceptance unit.

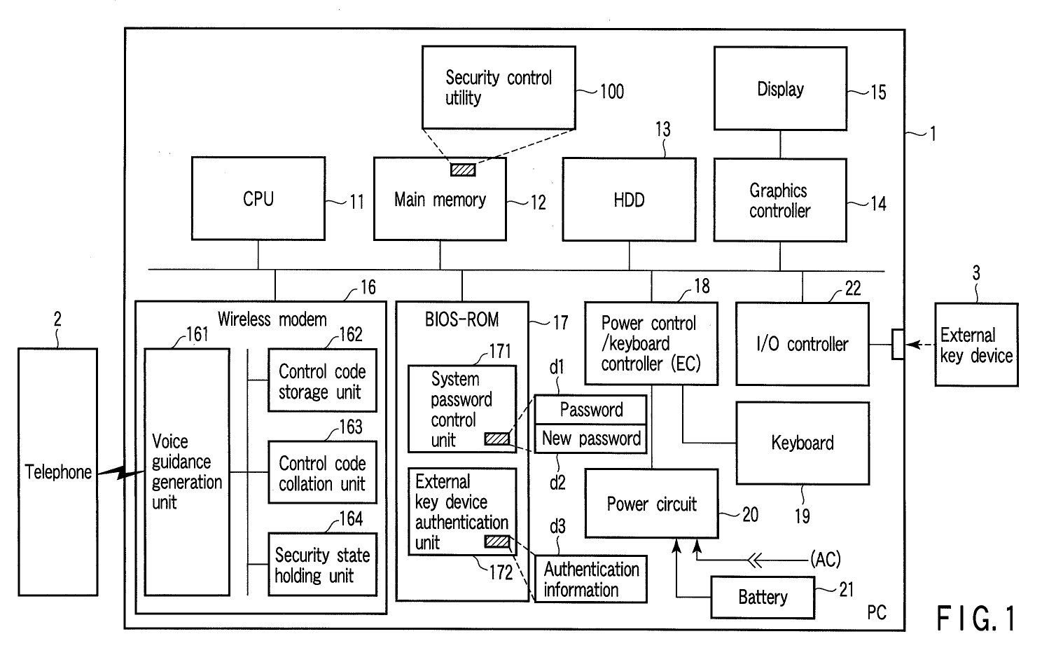

In FIG. 1, there is shown the configuration of an information processing apparatus according to the embodiment. The information processing apparatus is realized as a battery-powered notebook type personal computer.

As shown in FIG. 1, a computer 1 includes CPU 11, main memory 12, hard disk drive (HDD) 13, graphics controller 14 and display 15. The computer further includes wireless modem 16, BIOS-ROM 17, power control/keyboard controller (EC: Embedded Controller) 18, keyboard 19, power circuit 20, battery 21 and I/O controller 22.

The CPU 11 is a processor, which controls the operation of various components included in the computer. The CPU 11 executes various programs such as an operating system, utility and applications loaded from the HDD 13 to the main memory 12. In the computer 1, a security control utility 100 described later operates as one of various programs. The CPU 11 further executes a BIOS (basic input/output system) stored in the BIOS-ROM 17.

The BIOS is a program for controlling various hardware. In the following description, the BIOS itself is referred as BIOS 17.

The main memory 12 is a storage medium used as a main storage of the computer 1. The main memory 12 temporarily stores various programs executed by the CPU 11 and various input/output data of the programs. The HDD 13 is a storage medium used as an external storage of the computer 1. The HDD 13 permanently stores a large amount of various programs and data as an auxiliary memory of the main memory 12.

The graphics controller 14 is a display controller for controlling the display 15. The display 15 is an output device used as an output side of a user interface provided by the computer 1.

The wireless modem 16 is a communication device in a wireless service area where an access point and a base station are formed in a predetermined geographical area. The communication device, that is, the wireless modem 16 receives and sends a wireless signal for data communication or voice call between the corresponding access point and the base station. The computer 1 has the built-in wireless modem 16, and thereby, the computer makes a data communication for voice call with a telephone 2. The BIOS-ROM 17 is a storage medium storing a program rewritable BIOS.

The EC 18 is a one-chip microcomputer, which is integrated with two controllers, that is, a power management controller and a controller for controlling the keyboard 19. The EC 18 supplies power from the battery 21 or an external AC power supply in cooperation with the power circuit 20. The power from the power circuit 20 is always supplied to the wireless modem 16 and the EC 18 regardless of a power on/off state of the computer 1. The I/O controller 22 makes a connection with various external devices, including an external key device 3 shown in FIG. 1.

As described above, the computer 1 is realized as a battery-powered notebook type personal computer. For this reason, the computer 1 has a high possibility of being stolen or lost as compared with a desktop computer such as a desktop personal computer. Thus, the computer 1 has the following mechanism functioning when it is stolen or lost. For example, according to the foregoing mechanism, data stored in the HDD 13 is prevented from being leaked to a third party by a simple operation using a generally available telephone. The following is a detailed explanation about the mechanism.

In the computer 1, the BIOS 17 has a system password control unit 171 and an external key device authentication unit 172 to provide a basic security function. The system password control unit 171 executes the following security control. According to the security control, the control unit 171 requests a password input when the computer 1 boots, and the boot of the computer 1 is permitted only when a registered password is input. On the other hand, the external key device authentication unit 172 executes the following security control. According to the security control, when the computer 1 boots, the boot is permitted only when a predetermined key is acquired from the external key device 3 via the I/O controller 22.

The security control utility 100 provides a user interface for setting on/off of the security function by the system password control unit 171 and the external key device authentication unit 172. The security control utility 100 further executes the following settings in addition to the foregoing on/off of the security function. The security control utility 100 sets a password d1 held for making a comparison with the input password of the system password control unit 171, and a password d2 for changing the password d1 provided against emergencies. The security control utility 100 further sets authentication information d3 held for key authentication shared between the external key device authentication unit 172 and the external key device 3.

The computer 1 has the wireless modem 16, including the following various elements, to realize the reinforcement and operation of the security function by a simple operation using a generally available telephone. The wireless modem 16 includes voice guidance generation unit 161, control code storage unit 162, control code collation unit 163 and security state holding unit 164.

For example, a call is made by a telephone 2 with respect to a telephone number assigned to the wireless modem 16, that is, the wireless modem receives a call. In this case, the voice guidance generation unit 161 properly generates and sends a voice (speech) guidance wireless signal to the telephone 2. First, the voice guidance generation unit 161 generates and sends a voice (speech) guidance wireless signal for requesting to input a collation password (personal identification number) (using the dialing buttons of the telephone 2).

The control code storage unit 162 holds a personal identification number (password) to be transmitted from the telephone 2 and a number for selecting any of the following security functions as a control code. One is a security function (e.g., “1”) of the system password control unit 171. Another is a security function (e.g., “2”) of the external key device authentication unit 172. Another is the foregoing two functions combined (e.g., “3”). The security control utility 100 can set the personal identification number (password).

The control code collation unit 163 collates the personal identification number (password) sent from the telephone 2, and checks whether or not the transmitted select number is effective. If the personal identification number (password) sent from the telephone 2 matches the number held in the control code storage unit 162, the control code collation unit 163 gives the following instructions. Namely, the control code collation unit 163 gives an instruction to generate and send a voice guidance wireless signal for selecting any of the security functions to the voice guidance generation unit 161.

When receiving the forgoing instructions, the voice guidance generation unit 161 generates and sends a voice guidance wireless signal for selecting any of the security functions. Then, the generation unit 161 transfers a number sent from the telephone 2 in response to the voice guidance to the control code collation unit 163. Thereafter, the control code collation unit 163 checks whether or not the sent number is an effective number by a comparison with a number held in the control code storage unit 162. If the sent number is effective, the unit 163 stores the number (control code) in the security state holding unit 164.

In this case, the control code collation unit 163 makes communications with the EC 18 via a bus to check whether or not the computer 1 is in a power-on state. When making communications with the EC 18 via a bus, the unit 163 sends a control signal for requesting to turn off the power of the computer via a bus. In this way, first, the power of the remote computer 1 is immediately turned off using the telephone 2, and thereby, data is prevented from being leaked.

Thereafter, when the computer 1 is powered on, the BIOS 17 takes the following procedure as one process of the boot processing. Specifically, the BIOS 17 checks whether or not the security state holding unit 164 of the wireless modem 16 is stored with any control code. For example, if the foregoing “1” or “3” is stored, the security function by the system password control unit 171 performs. Specifically, even if the security function of the system password control unit 171 is not previously set in an on-state by a user, the BIOS 17 again sets the security function by the system password control unit 171. Then, the system password control unit 171 changes the password from the password d1 to the password d2.

For example, if the foregoing “2” or “3” is stored, the BIOS 17 again sets the security function by the external key device authentication unit 172 even if the security function by the external key device authentication unit 172 is not previously set by a user. In this way, secondarily, the security function of the remote computer 1 is reinforced and operated using the telephone 2, and thereby, data is prevented from being leaked.

Specifically, for example, if the computer 1 is stolen by a third party, the computer 1 exists in a wireless service area formed by a base station. In this case, a user makes a telephone call using the number assigned to the wireless modem of the computer 1 using the telephone 2. In this way, if the computer 1 is in a power-on state, the user can immediately turn off the power. In addition, when the power of the computer 1 is turned on (even if the security function is not set), the user sets the boot condition satisfying one of a password input different from that used to date and connection of a predetermined external key device, or both of them.

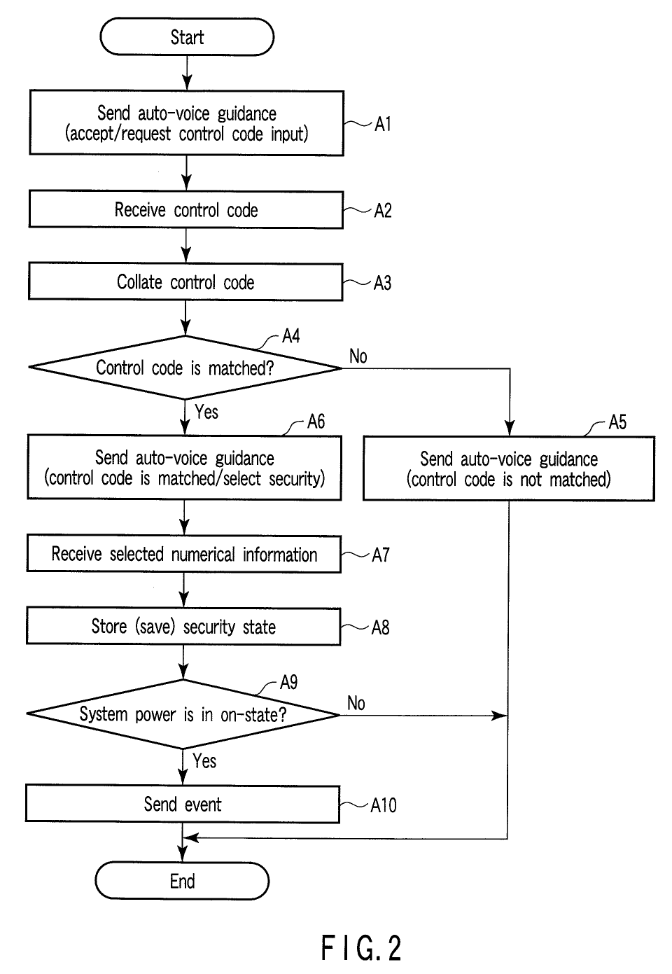

FIG. 2 is an exemplary flowchart to explain the procedure of the security function operation using the wireless modem of the computer 1.

When a call is made (from the telephone 2), the voice guidance generation unit 161 accepts the operation instructions of the security functions, and then, sends a voice guidance for inputting a password (personal identification number) (block A1). Then, the generation unit 161 receives the password sent in response to the voice guidance, and transfers the password to the control code collation unit 163 (block A2).

The control code collation unit 163 collates the password transferred from the voice guidance generation unit 161 by making a comparison with the control code held in the control code storage unit 162 (block A3). If the password does not match with the control code (NO in block A4), the unit 163 sends a voice guidance notifying that the input password is not suitable to the voice guidance generation unit 161 (block A5). Thus, the procedure ends. Conversely, if the password matches with the control code (YES in block A4), the control code collation unit 163 notifies that the input password is confirmed. Thereafter, the unit 163 sends a voice guidance for selecting a security function operation to the voice guidance generation unit 161 (block AG).

The voice guidance generation unit 161 sends the voice guidance, and thereafter, receives the sent selected number, and then, transfers the selected number to the control code collation unit 163 (block A7). The control code collation unit 163 stores the selected number in the security state holding unit 164 (block A8). In this case, the unit 163 checks whether or not the computer 1 is in a power-on state (block A9). If the computer 1 is in a power-on state (YES in block A9), the control code collation unit 163 issues an event for turning off the power of the computer 1 (block A10). Thereafter, the procedure ends.

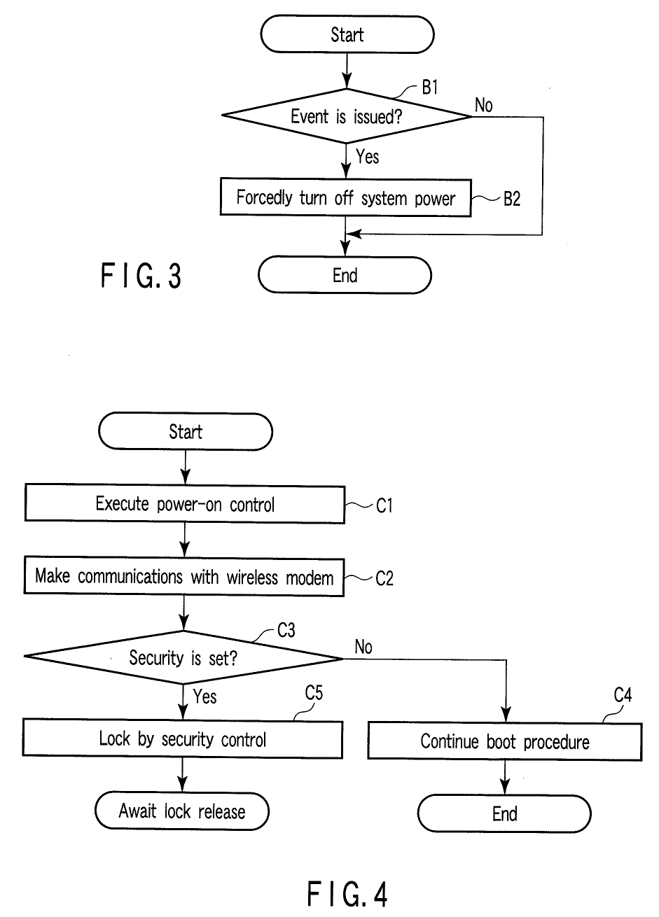

FIG. 3 is an exemplary flowchart to explain the procedure of a security function operation by the EC 18 of the computer 1.

If an event for turning off the power of the computer 1 occurs (YES in block B1), the EC 18 forcedly turns off the power of the computer 1 (block B2).

FIG. 4 is an exemplary flowchart to explain the procedure of a security function operation of the BIOS 17 of the computer 1.

When the computer is powered on, the BIOS 17 executes a normal power-on control (block C1). Thereafter, the BIOS 17 makes communications with the wireless modem 16 (block C2). The BIOS 17 makes communications with the wireless modem 16, and thereby, checks whether or not any security function is set (block C3). If no security function is set (NO in block C3) the BIOS 17 continues the next boot procedure (block C4).

Conversely, If a security function is set (YES in block C3), the BIOS 17 transfers the computer 1 to a locked state by one or both of the system password control unit 171 and the external key device authentication unit 172 (block C5).

The computer of this embodiment realizes the security function operation using a voice communication function of the wireless modem which is not used, but is, nevertheless built therein.

According to this embodiment, the security function of the system password control unit 171, the security function of the external key device authentication unit 172 or both of them are selected using the telephone 2. However, the security control utility 100 may previously set either of the security functions, and then stores such setting in the wireless modem 16. In this case, when the telephone 2 is used, the password only is input as a request condition. If the password is matched, the previously set security control may be executed.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information processing apparatus, comprising:
a wireless communication module configured to receive a first wireless signal comprising a voice communication from one of a plurality of base stations and configured to transmit a second wireless signal comprising a voice communication to one of a plurality of base stations;
an acceptance module configured to process instructions related to a privacy protection operation in the first wireless signal; and
a controller configured to control the privacy protection operation in accordance with the instructions.

2. The apparatus of claim 1, further comprising a forced-power-off module configured to turn off the information processing apparatus,
and wherein the controller is configured to cause the forced-power-off module to turn off of the information processing apparatus if the information processing apparatus is in a power-on state when the acceptance module processes the instructions.

3. The apparatus of claim 1, further comprising a password change module configured to change a booting password from a first password to a predetermined second password for emergency, the booting password is required when the information processing apparatus boots,
wherein the controller is configured to cause the password change module to change the booting password when an instruction processed by the acceptance module is a password change.

4. The apparatus of claim 1, further comprising a lock module configured to activate a lock function of requiring acquisition of a predetermined key from an external key device as a condition for the information processing apparatus to boot,
wherein the controller is configured to cause the lock module to activate the lock function when an instruction received at the acceptance module is of an activation of the lock function.

5. The apparatus of claim 1, wherein the acceptance module comprises:
a transmission module configured to send a guidance message of requesting an input of a collation password via the wireless communication module;
a reception module configured to receive a password via the wireless communication module in response to the guidance message
a control code storage module that is configured to hold a password to be transmitted on the wireless signal; and
a determining module configured to determine whether or not the received password corresponds to the password held in the control code storage module.

6. The apparatus of claim 5, wherein the acceptance module further comprises:
a second transmission module configured to send a guidance message to a user requesting to select privacy protection operations via the wireless communication means; and
a third transmission module configured to transmit the selected privacy protection operation according to an instruction in response to the guidance message to the controller.

7. An information processing apparatus, comprising:
a wireless modem comprising a wireless communication module configured to receive a first wireless signal comprising voice communication from one of a plurality of base stations and configured to transmit a second wireless signal comprising voice communication to one of a plurality of base stations, and an acceptance module configured to process instructions related to a privacy protection operation in the first wireless signal;
a privacy protection module configured to carry out a privacy protection operation in accordance with an instruction processed by the acceptance module of the wireless modem; and
a power control module configured to constantly supply power to the wireless modem regardless of a power state of the information processing apparatus.
